(19) United States
(12) Patent Application Publication
(10) Pub. No.: US 2024/0333555 A1
(43) Pub. Date: Oct. 3, 2024

(54) COMMUNICATION SYSTEM, NON-TRANSITORY COMPUTER READABLE MEDIUM, AND COMMUNICATION METHOD

(71) Applicant: FUJIFILM Business Innovation Corp., Tokyo (JP)

(72) Inventors: Masato SUGII, Kanagawa (JP); Satoshi WATANABE, Kanagawa (JP); Haruhisa HOSHINO, Kanagawa (JP); Hiroshige NONAKA, Kanagawa (JP)

(73) Assignee: FUJIFILM Business Innovation Corp., Tokyo (JP)

(21) Appl. No.: 18/447,312

(22) Filed: Aug. 10, 2023

(30) Foreign Application Priority Data
Mar. 29, 2023 (JP) 2023-053053

(51) Int. Cl. H04L 12/66; H04L 61/10

(52) U.S. Cl. CPC H04L 12/66; H04L 61/10; H04L 61/4511

(57) ABSTRACT

A communication system for an information processing apparatus including plural communication interfaces for connecting to plural networks, includes one or plural processors configured to: determine, based on correspondence information in which a network number of each of the plural networks accessible via a gateway on the network that the information processing apparatus is able to connect to and a communication interface used for connecting to the gateway are associated with each other, a communication interface to be used for connecting to a network having a network number that matches a network number of an address of a communication destination from among the plural communication interfaces; and connect to the communication destination using the determined communication interface.

### CROSS-REFERENCE TO RELATED APPLICATIONS

This application is based on and claims priority under 35 USC 119 from Japanese Patent Application No. 2023-053053 filed Mar. 29, 2023.

### BACKGROUND

### (i) Technical Field

The present disclosure relates to a communication system, a non-transitory computer readable medium, and a communication method.

### (ii) Related Art

An information processing apparatus communicating with external apparatuses via networks may include a plurality of network adaptors that are connected to different networks. In the case where it is unclear via which network the information processing apparatus is to connect to a specific communication destination, a technique for identifying a communication destination on the basis of results of name resolution by domain name system (DNS) servers on the networks has been used.

In Japanese Unexamined Patent Application Publication No. 2021-118437, a communication system that performs name resolution for accessing an external communication apparatus more securely by performing control to acquire information on an IP network to be accessed among a plurality of IP networks, transmit a request for name resolution to a DNS server corresponding to the IP network whose information is acquired, and not to transmit a request for name resolution to a DNS server not corresponding to the IP network whose information is acquired, is disclosed.

In Japanese Unexamined Patent Application Publication No. 2021-197687, a communication system that externally requests name resolution of a hostname, identifies, in a case where the requested name resolution of the hostname is successful, a communication interface with which a DNS server that has succeeded the name resolution is associated, and registers route information for performing communication with an external apparatus identified by an IP address obtained as a result of the name resolution via the identified communication interface into a routing table, is disclosed.

### SUMMARY

To transmit data only to a specific communication destination on a specific network, it is necessary to identify a correct communication route to the communication destination. However, depending on the configuration of a network, a communication route to a communication destination is unable to be identified only based on the result of name resolution by a DNS server.

Aspects of non-limiting embodiments of the present disclosure relate to providing a communication system capable of identifying a communication route to a communication destination for an information processing apparatus connected to a plurality of networks, compared to a method for identifying a communication destination based on the result of name resolution by a DNS server.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a communication system for an information processing apparatus including a plurality of communication interfaces for connecting to a plurality of networks. The communication system includes one or a plurality of processors configured to: determine, based on correspondence information in which a network number of each of the plurality of networks accessible via a gateway on the network that the information processing apparatus is able to connect to and a communication interface used for connecting to the gateway are associated with each other, a communication interface to be used for connecting to a network having a network number that matches a network number of an address of a communication destination from among the plurality of communication interfaces; and connect to the communication destination using the determined communication interface.

### BRIEF DESCRIPTION OF THE DRAWINGS

Exemplary embodiment of the present disclosure will be described in detail based on the following figures, wherein:

FIG. 1 is a diagram illustrating an example of the configuration of a network environment including an information processing apparatus to which an exemplary embodiment is applied;

FIG. 2 is a diagram illustrating a configuration of the information processing apparatus;

FIG. 3 is a diagram illustrating an example of the hardware configuration of the information processing apparatus;

FIG. 4 is a diagram illustrating an example of interface information;

FIG. 5 is a diagram illustrating an example of a routing table;

FIG. 6 is a diagram illustrating an example of DNS information; and

FIG. 7 is a flowchart illustrating a method for determining a communication interface to be used for communication.

### DETAILED DESCRIPTION

An exemplary embodiment of the present disclosure will be described in detail below with reference to drawings.

### <System Configuration>

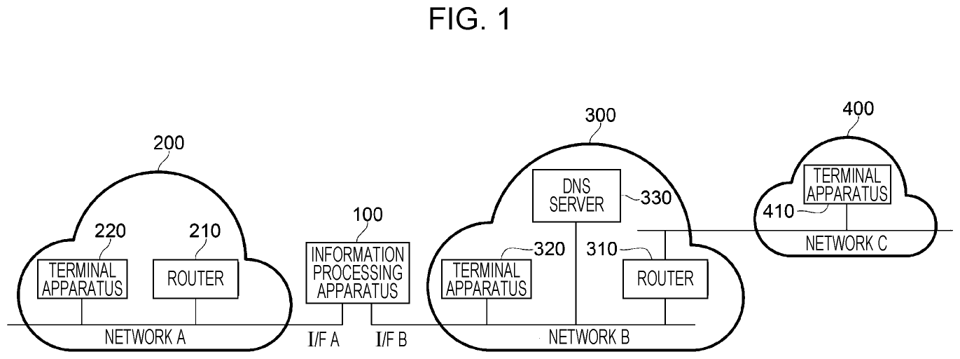

FIG. 1 is a diagram illustrating an example of the configuration of a network environment including an information processing apparatus to which an exemplary embodiment is applied. An information processing apparatus 100 includes a plurality of communication interfaces (I/F A and I/F B) and is connected to a plurality of networks. In the example illustrated in FIG. 1, the information processing apparatus 100 is connected to two networks (a network A and a network B). The information processing apparatus 100 is not limited to a specific type of apparatus as long as it is capable of connecting to a network and performing data exchange with an external information apparatus. For example, a personal computer, an image processing apparatus including a communication function for connecting to a network, or the like may be used as the information processing apparatus 100.

A router 210 and a terminal apparatus 220 are connected to a network A 200. A router 310, a terminal apparatus 320, and a DNS server 330 are connected to a network B 300. Furthermore, a network C 400 is connected to the network B 300 via the router 310. A terminal apparatus 410 is connected to the network C 400. The information processing apparatus 100 is also capable of connecting to the network C 400 via the router 310 of the network B 300. The network A 200, the network B 300, and the network C 400 are assumed to be Internet Protocol (IP) networks.

In FIG. 1, a state in which a single terminal apparatus, that is, the terminal apparatus 220, is connected to the network A 200, a single terminal apparatus, that is, the terminal apparatus 320, is connected to the network B 300, and a single terminal apparatus, that is, the terminal apparatus 410, is connected to the network C 400 is illustrated. However, FIG. 1 only schematically illustrates a configuration of the network A 200, the network B 300, and the network C 400. In actuality, a plurality of terminal apparatuses may be connected to each of the network A 200, the network B 300, and the network C 400.

<Configuration of information processing apparatus 100>

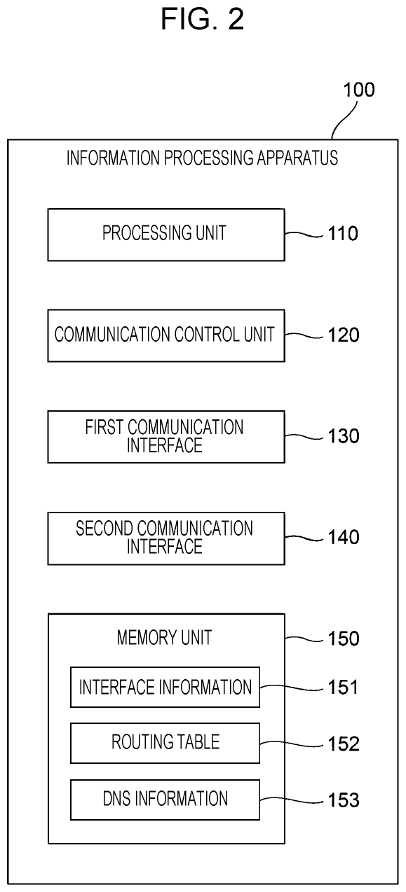

FIG. 2 is a diagram illustrating a configuration of the information processing apparatus 100. The information processing apparatus 100 includes a processing unit 110, a communication control unit 120, a first communication interface 130, a second communication interface 140, and a memory unit 150.

The processing unit 110 performs various types of processing including arithmetic processing and control. Various types of processing are performed by the processing unit 110 in accordance with the type of the information processing apparatus 100, a program executed by the information processing apparatus 100, and the like, and types of processing performed by the information processing apparatus 100 are not particularly limited. For example, in the case where an image processing apparatus is used as the information processing apparatus 100, the processing unit 110 performs image reading processing, image conversion processing, image forming processing, control of functions of the information processing apparatus 100, and the like. Furthermore, processing performed by the processing unit 110 includes processing for transmitting data to an external apparatus and processing for receiving data from an external apparatus.

For data exchange between the information processing apparatus 100 and an external apparatus, the communication control unit 120 controls transmission and reception of the data. The communication control unit 120 also determines a communication interface to be used (in this case, the first communication interface 130 or the second communication interface 140) according to a communication destination for data transmission and reception. A method for determining a communication interface to be used will be described later.

The first communication interface 130 is an interface for connecting to the network A 200. The first communication interface 130 has an address (IP address) on the network A 200. The second communication interface 140 is an interface for connecting to the network B 300. The second communication interface 140 has an address (IP address) on the network B 300. The first communication interface 130 and the second communication interface 140 may be implemented by individual network cards and connectors.

The memory unit 150 stores data to be used for processing by the processing unit 110 and processing results. The memory unit 150 also stores information to be used for communication control by the communication control unit 120. Information to be used for communication control includes interface information 151 as information on the first communication interface 130 and the second communication interface 140, a routing table 152 as route information on networks, DNS information 153 as information regarding a DNS server on a network, and the like.

### <Hardware Configuration>

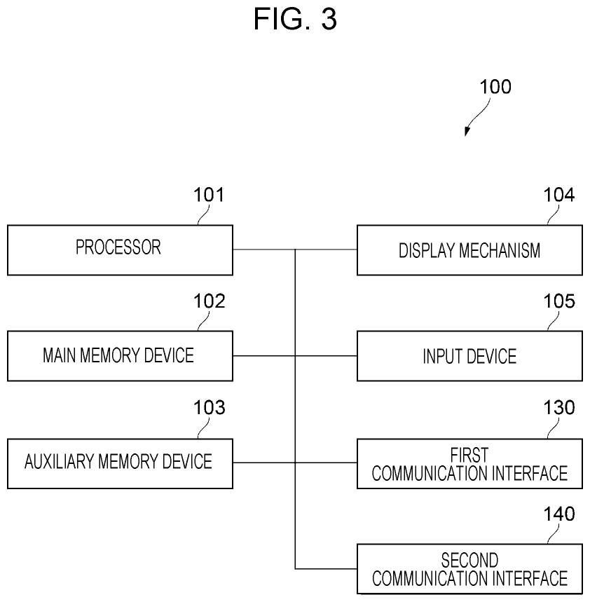

FIG. 3 is a diagram illustrating an example of the hardware configuration of the information processing apparatus 100. The information processing apparatus 100 is implemented by, for example, a computer illustrated in FIG. 3. The computer illustrated in FIG. 3 includes one or a plurality of processors 101 as arithmetic means, a main memory device 102 as memory means, and an auxiliary memory device 103 as memory means. The one or the plurality of processors 101 each execute functions of the information processing apparatus 100 by reading a program stored in the auxiliary memory device 103 into the main memory device 102 and executing the program. As the processor 101, for example, a central processing unit (CPU), a microprocessing unit (MPU), a graphics processing unit (GPU), a digital signal processor (DSP), or the like is used. As the main memory device 102, for example, a random access memory (RAM) is used. As the auxiliary memory device 103, for example, a magnetic disk device, a solid state drive (SSD), or the like is used.

The computer also includes a display mechanism 104 for providing display on a display device and an input device 105 on which an input operation is performed by an operator of the computer. As the input device 105, for example, a keyboard, a mouse, and the like are used. As described above with reference to FIG. 2, the computer includes the first communication interface 130 and the second communication interface 140 for connecting to networks. The configuration of the computer illustrated in FIG. 3 is merely an example. A computer used in this exemplary embodiment does not necessarily have the configuration illustrated in FIG. 2. For example, the computer may include a nonvolatile memory such as a flash memory and a read only memory (ROM) as memory devices.

In the case where the information processing apparatus 100 illustrated in FIG. 2 is the computer illustrated in FIG. 3, functions of the processing unit 110 and the communication control unit 120 are implemented by, for example, the processor 101 executing a program. The memory unit 150 is implemented by, for example, the main memory device 102 and the auxiliary memory device 103.

### <Information Used for Communication Control>

As described above, the interface information 151, the routing table 152, the DNS information 153, and the like are stored in the memory unit 150 of the information processing apparatus 100 as information to be used for communication control. The information to be used for communication control will be described below.

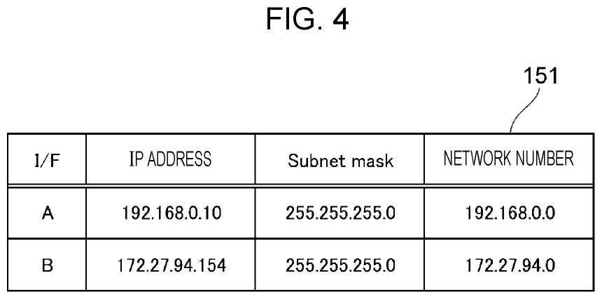

FIG. 4 is a diagram illustrating an example of the interface information 151. In the interface information 151, information regarding each of the first communication interface 130 and the second communication interface 140, such as items including “identification information” (“I/F” in FIG. 4) of each of the communication interfaces, “IP address”, “subnet mask”, and “network number”, is registered and managed. In FIG. 4, “A” as “identification information (I/F)” represents the first communication interface 130, and “B” as “identification information (I/F)” represents the second communication interface 140.

IP addresses of the first communication interface 130 and the second communication interface 140 on networks that the first communication interface 130 and the second communication interface 140 connect to are registered in the item “IP address”. In the example illustrated in FIG. 4, the IP address of the first communication interface 130 is 192.168.0.10, and the IP address of the second communication interface 140 is 172.27.94.154.

Subnet masks set for the first communication interface 130 and the second communication interface 140 are registered in the item “subnet mask”. In the example illustrated in FIG. 4, the subnet masks of both the first communication interface 130 and the second communication interface 140 are 255.255.255.0.

A network number of the network A 200 that the first communication interface 130 connects to and a network number of the network B 300 that the second communication interface 140 connects to are registered in the item “network number”. A network number is obtained by multiplying the value of an IP address by the value of a subnet mask. In the example illustrated in FIG. 4, the network number of the network A 200 is 192.168.0.0, and the network number of the network B 300 is 172.27.94.0.

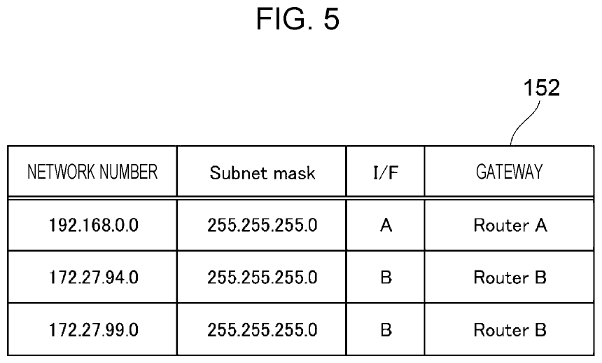

FIG. 5 is a diagram illustrating an example of the routing table 152. In the routing table 152, information regarding each of the networks that the first communication interface 130 and the second communication interface 140 are able to connect to, such as “network number”, “subnet mask”, “identification information” (“I/F” in FIG. 5) of each of the communication interfaces, and “gateway”, is registered and managed. Information in the routing table 152 is exchanged between routers on networks and is able to be acquired from routers on the networks using routing protocols. Acquisition of information using a routing protocol is performed according to a preset acquisition condition such as making periodic queries to a router, regardless of communication to an address of a communication destination.

Network numbers of networks accessible by the first communication interface 130 and the second communication interface 140 are registered in the item “network number”. In the example illustrated in FIG. 5, three network numbers: 192.168.0.0, 172.27.94.0, and 172.27.99.0, are registered. In the illustrated example, a network with the network number 172.27.99.0 is the network number of the network C 400 connected to the router 310 of the network B 300.

Subnet masks set for the network A 200, the network B 300, and the network C 400 are registered in the item “subnet mask”. In the example illustrated in FIG. 5, the subnet masks of all the network A 200, the network B 300, and the network C 400 are 255.255.255.0.

Identification information on communication interfaces used for connecting to networks with network numbers for acquisition of information in the routing table 152 is registered in the item “identification information (I/F)”. In the example illustrated in FIG. 5, the communication interface used for connecting to the network with the network number of 192.168.0.0 is the first communication interface 130 because the identification information indicates “A”. The communication interface used for connecting to the network with the network number of 172.27.94.0 is the second communication interface 140 because the identification information indicates “B”. The communication interface used for connecting to the network with the network number of 172.27.99.0 is the second communication interface 140 because the identification information indicates “B”.

Identification information on gateways used for connection to networks with network numbers is registered in the item “gateway”. In this example, routers of networks correspond to gateways. In FIG. 5, the router 210 of the network A 200 is described as “Router A”, and the router 310 of the network B 300 is described as “Router B”. Thus, in the example illustrated in FIG. 5, the router used for connecting to the network with the network number of 192.168.0.0 is the router 210. Furthermore, the router used for connecting to the network with the network number of 172.27.94.0 is the router 310. Furthermore, the router used for connecting to the network with the network number of 172.27.99.0 is the router 310.

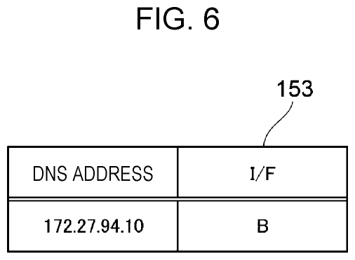

FIG. 6 is a diagram illustrating an example of the DNS information 153. In the DNS information 153, information regarding a DNS server that the information processing apparatus 100 is able to connect to, such as “DNS address” and “identification information” (“I/F” in FIG. 6) of a communication interface, is registered and managed. Information on a DNS server is registered in advance in the DNS information 153 by a user. In the network environment illustrated in FIG. 1, since the information processing apparatus 100 is able to connect to only the DNS server 330 of the network B 300, information on the DNS server 330 is registered as the DNS information 153 in FIG. 6.

An IP address of a DNS server is registered in the item “DNS address”. In the example illustrated in FIG. 6, the IP address 172.27.94.10 of the DNS server 330 of the network B 300 is registered.

Identification information on a communication interface used for connecting to the DNS server is registered in the item “identification information (I/F)”. In the example illustrated in FIG. 6, the communication interface used for connecting to the DNS server 330 of the network B 300 is the second communication interface 140 because the identification information indicates “B”.

### <Method for Determining Communication Interface to be Used>

Next, a method for determining a communication interface to be used by the information processing apparatus 100 for connecting to an external apparatus will be described. As is clear from the network environment illustrated in FIG. 1, the information processing apparatus 100 determines, according to a network of a connection destination, which one of the first communication interface 130 and the second communication interface 140 to use. The various types of information illustrated in FIGS. 4 to 6 are used for determination regarding a communication interface to be used.

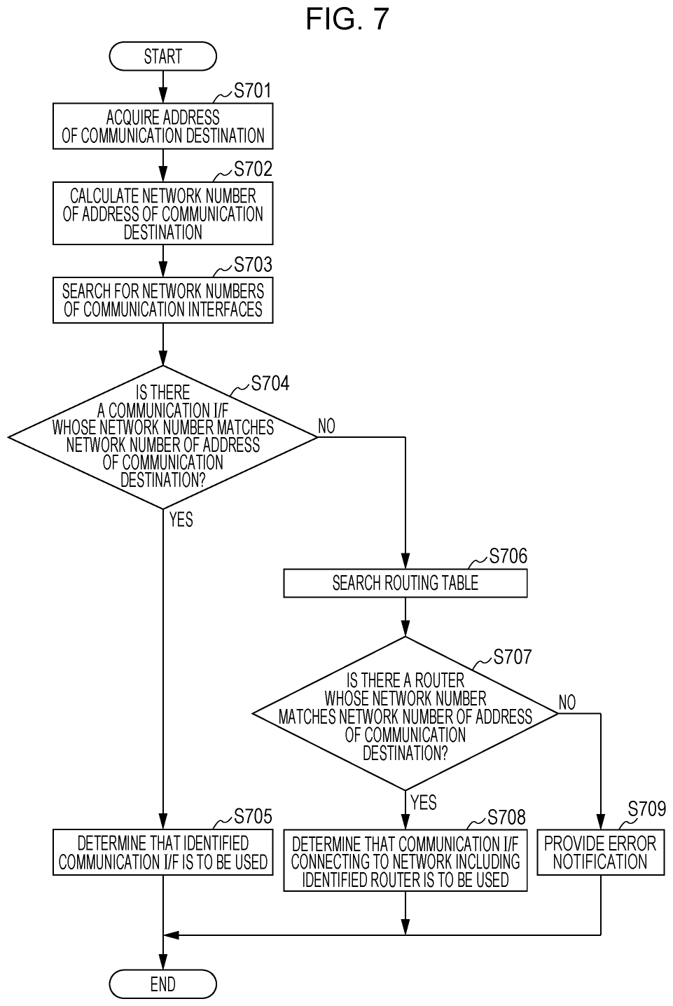

FIG. 7 is a flowchart illustrating a method for determining a communication interface to be used for communication. To communicate with an external apparatus, the information processing apparatus 100 acquires an address of a communication destination (S701). The address of the communication destination may be acquired by receiving an input operation by a user or may be acquired using a function of an application program or the like.

The communication control unit 120 of the information processing apparatus 100 calculates a network number of the acquired address of the communication destination (S702). The network number of the address of the communication destination is obtained by multiplying the value of the address of the communication destination acquired in S701 by the value of a preset subnet mask.

Next, the communication control unit 120 searches for network numbers of the first communication interface 130 and the second communication interface 140 (S703). The network numbers of the first communication interface 130 and the second communication interface 140 are, for example, read from the interface information 151, which has been described above with reference to FIG. 4. In the example illustrated in FIG. 4, the network number of the first communication interface 130 is 192.168.0.0, and the network number of the second communication interface 140 is 172.27.94.0.

Next, the communication control unit 120 determines whether or not each of the network number of the first communication interface 130 and the network number of the second communication interface 140 detected in S703 matches the network number calculated from the communication destination address. In the case where the network number of the first communication interface 130 or the network number of the second communication interface 140 matches the network number of the communication destination address (YES in S704), the communication control unit 120 determines that the communication interface whose network number matches the network number of the communication destination address is to be used for communication (S705).

In the case where neither the network number of the first communication interface 130 nor the network number of the second communication interface matches the network number of the communication destination address (NO in S704), the communication control unit 120 searches the routing table 152 (S706) and determines whether or not a network number of a router registered in the routing table 152 matches the network number calculated from the communication destination address. In the case where there is a router whose network number matches the network number of the communication destination address (YES in S707), the communication control unit 120 determines that a communication interface connecting to a network including the router whose network number matches the network number of the communication destination address is to be used for communication (S708).

In the case where there is no router whose network number matches the network number of the communication destination address (NO in S707), the communication control unit 120 is unable to determine a communication interface to be used for communication. In this case, the information processing apparatus 100 provides an error notification for notifying the user that communication to the address of the communication destination acquired in S701 is unable to be achieved and then ends the process (S709).

Now, an example of the determination of a communication interface to be used in the case where the information illustrated in FIGS. 4 to 6 is registered in the interface information 151, the routing table 152, and the DNS information 153 will be described below with reference to the flowchart of FIG. 7. In this example, communication interfaces to be used for the terminal apparatus 220 connected to the network A 200, the terminal apparatus 320 connected to the network B 300, and the terminal apparatus 410 connected to the network C 400 illustrated in FIG. 1 as communication destinations are determined. Furthermore, the address of the terminal apparatus 220 is 192.168.0.13, the address of the terminal apparatus 320 is 172.27.94.23, and the address of the terminal apparatus 410 is 172.27.99.33.

To communicate with the terminal apparatus 220, the information processing apparatus 100 first acquires the address 192.168.0.13 of the terminal apparatus 220 (S701). Next, the communication control unit 120 of the information processing apparatus 100 calculates, based on the subnet mask 255.255.255.0, the network number 192.168.0.0 of the network that the terminal apparatus 220 connects to (S702)

Next, the communication control unit 120 searches for the network number of the first communication interface 130 and the network number of the second communication interface 140 (S703). According to the interface information 151 illustrated in FIG. 4, the network number 192.168.0.0 of the first communication interface 130 matches the network number calculated in S702 (YES in S704). Thus, the communication control unit 120 determines that the first communication interface 130 is a communication interface to be used for communication with the terminal apparatus 220 (S705).

Furthermore, to communicate with the terminal apparatus 320, the information processing apparatus 100 first acquires the address 172.27.94.23 of the terminal apparatus 320 (S701). Next, the communication control unit 120 of the information processing apparatus 100 calculates, based on the subnet mask 255.255.255.0, the network number 172.27.94.0 of the network that the terminal apparatus 320 connects to (S702).

Next, the communication control unit 120 searches for the network number of the first communication interface 130 and the network number of the second communication interface 140 (S703). According to the interface information 151 illustrated in FIG. 4, the network number 172.27.94.0 of the second communication interface 140 matches the network number calculated in S702 (YES in S704). Thus, the communication control unit 120 determines that the second communication interface 140 is a communication interface to be used for communication with the terminal apparatus 320 (S705).

Furthermore, to communicate with the terminal apparatus 410, the information processing apparatus 100 first acquires the address 172.27.99.33 of the terminal apparatus 410 (S701). Next, the communication control unit 120 of the information processing apparatus 100 calculates, based on the subnet mask 255.255.255.0, the network number 172.27.99.0 of the network that the terminal apparatus 320 connects to (S702).

Next, the communication control unit 120 searches for the network number of the first communication interface 130 and the network number of the second communication interface 140 (S703). However, neither the network number of the first communication interface 130 nor the network number of the second communication interface 140 matches the network number calculated in S702 (NO in S704). Thus, the communication control unit 120 then searches the routing table 152 (S706).

According to the routing table 152 illustrated in FIG. 5, the network number 172.27.99.0 that matches the network number calculated in S702 is registered (YES in S707), and a gateway used for connecting to a network having this network number is the router 310 of the network B 300. Thus, the communication control unit 120 determines that the second communication interface 140 that connects to the network B 300 is a communication interface to be used for communication with the terminal apparatus 410 (S708).

In the case where a communication destination is specified not by an address but by a full qualified domain name (FQDN) including a host name and a domain name, name resolution by DNS needs to be performed. In this case, the communication control unit 120 connects to a DNS server that the first communication interface 130 or the second communication interface 140 is able to connect to, and performs name resolution. Name resolution is processing for converting an FQDN into an IP address. In the network environment illustrated in FIG. 1, a DNS server that the information processing apparatus 100 is able to connect to is only the DNS server 330 of the network B 300, and information on a communication interface (in this case, the second communication interface 140) that is able to access the DNS server 330 is registered in the DNS information 153 illustrated in FIG. 6. Thus, the communication control unit 120 refers to the DNS information 153 to connect to the DNS server 330, performs name resolution, and acquires the address of the communication destination.

An exemplary embodiment of the present disclosure has been described above. However, the technical scope of the present disclosure is not limited to the exemplary embodiment described above. For example, although the information processing apparatus 100 includes the two communication interfaces: the first communication interface 130 and the second communication interface 140, in the exemplary embodiment described above, the information processing apparatus 100 may include three or more communication interfaces. In addition to the number of communication interfaces provided in the information processing apparatus 100, various changes and replacement of configurations without departing from the scope of the technical concept of the present disclosure are included in the present disclosure. In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### <Appendix>

(((1)))

A communication system for an information processing apparatus including a plurality of communication interfaces for connecting to a plurality of networks, the communication system comprising: one or a plurality of processors configured to: determine, based on correspondence information in which a network number of each of the plurality of networks accessible via a gateway on the network that the information processing apparatus is able to connect to and a communication interface used for connecting to the gateway are associated with each other, a communication interface to be used for connecting to a network having a network number that matches a network number of an address of a communication destination from among the plurality of communication interfaces; and connect to the communication destination using the determined communication interface.

(((2)))

The communication system according to (((1))), wherein the one or the plurality of processors are configured to: acquire route information on each of the plurality of networks that the information processing apparatus is able to connect to using the plurality of communication interfaces from the gateway on the network; store correspondence information in which a network number of a network accessible via the gateway obtained from the acquired route information and a communication interface used for connecting to the gateway are associated with each other into a memory device; and determine, based on the correspondence information stored in the memory device, the communication interface to be used for connecting to the network having the network number that matches the network number of the address of the communication destination.

(((3)))

The communication system according to (((2))), wherein the one or the plurality of processors are configured to acquire the route information according to a preset acquisition condition, regardless of whether or not communication to the address of the communication destination is made.

(((4)))

The communication system according to any one of (((1))) to (((3))), wherein the one or the plurality of processors are configured to: in a case where the communication destination is specified by a host name, request a DNS server that the information processing apparatus is able to connect to for name resolution; and extract a network number of the address of the communication destination obtained as a result of the name resolution and determine the communication interface to be used for connecting to the network having the network number that matches the extracted network number.

(((5)))

The communication system according to any one of (((1))) to (((4))), wherein DNS information in which an address of a DNS server that is able to be connected using the plurality of communication interfaces and a communication interface that is able to be used for connecting to the DNS server among the plurality of communication interfaces are associated with each other is stored in a memory device of the information processing apparatus, and wherein the one or the plurality of processors are configured to determine, based on the DNS information, the communication interface that is to connect to the DNS server and request, using the communication interface, the DNS server for name resolution.

(((6)))

The communication system according to any one of (((1))) to (((5))), wherein the one or the plurality of processors are configured to, in a case where any one of the network numbers of the networks that the plurality of communication interfaces connect to and the network number of the address of the communication destination match, connect to the communication destination by using a communication interface that connects to the network whose network number matches the network number of the address of the communication destination, irrespective of the correspondence information.

(((7)))

The communication system according to any one of (((1))) to (((6))), wherein the one or the plurality of processors are configured to acquire, based on an address of the information processing apparatus on a network that each of the plurality of communication interfaces connects to and a subnet mask regarding the network, a network number of the network.

(((8)))

A program for controlling a computer that is able to connect to a plurality of networks, the program causing the computer to execute: a function for acquiring route information on each of the plurality of networks that the computer is able to connect to from a gateway on the network; a function for storing correspondence information in which a network number of a network accessible via the gateway obtained from the acquired route information and a communication interface used for connecting to the gateway are associated with each other into a memory device; a function for determining, based on a network number of an address of a communication destination and the correspondence information stored in the memory device, a communication interface to be used; and a function for connecting to the communication destination using the determined communication interface.

What is claimed is:

1. A communication system for an information processing apparatus including a plurality of communication interfaces for connecting to a plurality of networks, the communication system comprising:
one or a plurality of processors configured to:
determine, based on correspondence information in which a network number of each of the plurality of networks accessible via a gateway on the network that the information processing apparatus is able to connect to and a communication interface used for connecting to the gateway are associated with each other, a communication interface to be used for connecting to a network having a network number that matches a network number of an address of a communication destination from among the plurality of communication interfaces; and
connect to the communication destination using the determined communication interface.

2. The communication system according to claim 1, wherein the one or the plurality of processors are configured to:
acquire route information on each of the plurality of networks that the information processing apparatus is able to connect to using the plurality of communication interfaces from the gateway on the network;
store correspondence information in which a network number of a network accessible via the gateway obtained from the acquired route information and a communication interface used for connecting to the gateway are associated with each other into a memory device; and
determine, based on the correspondence information stored in the memory device, the communication interface to be used for connecting to the network having the network number that matches the network number of the address of the communication destination.

3. The communication system according to claim 2, wherein the one or the plurality of processors are configured to acquire the route information according to a preset acquisition condition, regardless of whether or not communication to the address of the communication destination is made.

4. The communication system according to claim 1, wherein the one or the plurality of processors are configured to:
in a case where the communication destination is specified by a host name, request a DNS server that the information processing apparatus is able to connect to for name resolution; and
extract a network number of the address of the communication destination obtained as a result of the name resolution and determine the communication interface to be used for connecting to the network having the network number that matches the extracted network number.

5. The communication system according to claim 4,
wherein DNS information in which an address of a DNS server that is able to be connected using the plurality of communication interfaces and a communication interface that is able to be used for connecting to the DNS server among the plurality of communication interfaces are associated with each other is stored in a memory device of the information processing apparatus, and
wherein the one or the plurality of processors are configured to determine, based on the DNS information, the communication interface that is to connect to the DNS server and request, using the communication interface, the DNS server for name resolution.

6. The communication system according to claim 1, wherein the one or the plurality of processors are configured to, in a case where any one of the network numbers of the networks that the plurality of communication interfaces connect to and the network number of the address of the communication destination match, connect to the communication destination by using a communication interface that connects to the network whose network number matches the network number of the address of the communication destination, irrespective of the correspondence information.

7. The communication system according to claim 2, wherein the one or the plurality of processors are configured to, in a case where any one of the network numbers of the networks that the plurality of communication interfaces connect to and the network number of the address of the communication destination match, connect to the communication destination by using a communication interface that connects to the network whose network number matches the network number of the address of the communication destination, irrespective of the correspondence information.

8. The communication system according to claim 3, wherein the one or the plurality of processors are configured to, in a case where any one of the network numbers of the networks that the plurality of communication interfaces connect to and the network number of the address of the communication destination match, connect to the communication destination by using a communication interface that connects to the network whose network number matches the network number of the address of the communication destination, irrespective of the correspondence information.

9. The communication system according to claim 4, wherein the one or the plurality of processors are configured to, in a case where any one of the network numbers of the networks that the plurality of communication interfaces connect to and the network number of the address of the communication destination match, connect to the communication destination by using a communication interface that connects to the network whose network number matches the network number of the address of the communication destination, irrespective of the correspondence information.

10. The communication system according to claim 5, wherein the one or the plurality of processors are configured to, in a case where any one of the network numbers of the networks that the plurality of communication interfaces connect to and the network number of the address of the communication destination match, connect to the communication destination by using a communication interface that connects to the network whose network number matches the network number of the address of the communication destination, irrespective of the correspondence information.

11. The communication system according to claim 6, wherein the one or the plurality of processors are configured to acquire, based on an address of the information processing apparatus on a network that each of the plurality of communication interfaces connects to and a subnet mask regarding the network, a network number of the network.

12. The communication system according to claim 7, wherein the one or the plurality of processors are configured to acquire, based on an address of the information processing apparatus on a network that each of the plurality of communication interfaces connects to and a subnet mask regarding the network, a network number of the network.

13. The communication system according to claim 8, wherein the one or the plurality of processors are configured to acquire, based on an address of the information processing apparatus on a network that each of the plurality of communication interfaces connects to and a subnet mask regarding the network, a network number of the network.

14. The communication system according to claim 9, wherein the one or the plurality of processors are configured to acquire, based on an address of the information processing apparatus on a network that each of the plurality of communication interfaces connects to and a subnet mask regarding the network, a network number of the network.

15. The communication system according to claim 10, wherein the one or the plurality of processors are configured to acquire, based on an address of the information processing apparatus on a network that each of the plurality of communication interfaces connects to and a subnet mask regarding the network, a network number of the network.

16. A non-transitory computer readable medium storing a program causing a computer to execute a process for controlling the computer that is able to connect to a plurality of networks, the process comprising:
acquiring route information on each of the plurality of networks that the computer is able to connect to from a gateway on the network;
storing correspondence information in which a network number of a network accessible via the gateway obtained from the acquired route information and a communication interface used for connecting to the gateway are associated with each other into a memory device;
determining, based on a network number of an address of a communication destination and the correspondence information stored in the memory device, a communication interface to be used; and
connecting to the communication destination using the determined communication interface.

17. A communication method for controlling a computer that is able to connect to a plurality of networks, the communication method comprising:
acquiring route information on each of the plurality of networks that the computer is able to connect to from a gateway on the network;
storing correspondence information in which a network number of a network accessible via the gateway obtained from the acquired route information and a communication interface used for connecting to the gateway are associated with each other into a memory device;
determining, based on a network number of an address of a communication destination and the correspondence information stored in the memory device, a communication interface to be used; and
connecting to the communication destination using the determined communication interface.
